(19) United States
(12) Patent Application Publication
(10) Pub. No.: US 2015/0214706 A1
(43) Pub. Date: Jul. 30, 2015

(54) WATERTIGHT AND DUSTPROOF POWER CABLE GLAND

(71) Applicant: Excellence Optoelectronics Inc., Miaoli County (TW)

(72) Inventor: CHEN SHIH FENG, Chunan Town (TW)

(73) Assignee: Excellence Optoelectronics Inc., Miaoli County (TW)

(21) Appl. No.: 14/274,053

(22) Filed: May 9, 2014

(30) Foreign Application Priority Data
Jan. 24, 2014 (TW) 103201572

(51) Int. Cl. H02G 3/08; H02G 3/22

(52) U.S. Cl. CPC H02G 3/088; H02G 3/22

(57) ABSTRACT

A watertight and dustproof power cable gland comprises an annular base having a hole at the center thereof and having a groove along the sidewall thereof, wherein the groove has a protrusion member on the bottom thereof; a curved pipe interconnecting with the hole, wherein inner walls of the hole and curved pipe jointly form an inclined surface; and at least one fixing ring arranged on an external surface of the curved pipe. The watertight and dustproof power cable gland is installed on a separation board, and the protrusion member tightly contacts the separation board. A power cable passes the annular base and the curved pipe and is bound up with the opening of the curved pipe by a fixing strap. The present invention prevents liquid, dust and insects from entering an electric device via the cable gland and makes the cable gland less likely to drop out.

This application claims priority for Taiwan patent application no. 103201572 filed at Jan. 24, 2014, the content of which is incorporated by reference in its entirely.

### BACKGROUND OF THE INVENTION

1. Field of the Invention

The present invention relates to a power cable gland, particularly to a watertight and dustproof power cable gland, which not only can fix a power cable passing through the housing of an electric device but also can prevent liquid, dust and insects from entering the electric device.

2. Description of the Related Art

An electric device is driven by the electric power transmitted by a power cable passing a through-hole of the housing of the electric device. The conventional watertight and dustproof power cable gland is arranged in the abovementioned through-hole, allowing the power cable to extend from the interior to the exterior, protecting the power cable against abrasion, and preventing the electric device from short circuit.

With advance of science and technology, the elements and circuits of electric devices become more and more compact and delicate and likely to be short-circuited by the liquid or insects entering the electric devices. In order to prevent external substances and organisms from entering an electric device, the abovementioned through-hole is fabricated to have a size only allowing a power cable to pass. However, such a measure makes the user hard to change the power cable or adjust the length of the power cable. Further, the through-hole, which is exactly as large as the power cable, is likely to wear off the power cable while the power cable is being pulled. If there is a watertight and dustproof power cable gland is. installed in the through-hole, the watertight and dustproof power cable gland is likely to drop out while the power cable is being pulled. If the through-hole is obviously greater than the power cable, the user can easily adjust the power cable. However, external substances and organisms are likely to enter the electric device and damage the internal circuits and elements in such a case. So far, there is no watertight and dustproof power cable gland applicable to various sizes of power cables.

Accordingly, the present invention proposes a watertight and dustproof power cable gland to overcome the abovementioned problems and enhance the protection of power cables, circuits and elements of electric devices.

### SUMMARY OF THE INVENTION

The primary objective of the present invention is to provide a watertight and dustproof power cable gland, whose annular base and curved pipe have an inclined inner surface gradually descending from the interior toward the exterior, and whose curved pipe opening and power cable can be bound up by a fixing strap passing fixing rings, whereby the present invention can avoid the problem of the conventional watertight and dustproof power cable glands and effectively prevent liquid, dust and insects from entering the interior of an electric device, wherefore the present invention can protect the components and circuits inside the electric device more effectively.

Another objective of the present invention is to provide a watertight and dustproof power cable gland, wherein the annular base has a groove around the sidewall thereof, and wherein two walls of the groove respectively have different heights and separately contribute different torques to the separation board of an electric device, whereby the separation board is securely press-fitted to the groove, and whereby the watertight and dustproof power cable gland is unlikely to drop out while the power cable is being pulled.

In order to achieve the abovementioned objectives, the present invention proposes a watertight and dustproof power cable gland, which comprises an annular base, a curved pipe and at least one fixing ring. The annular base has at least one hole at the center thereof and a groove around the sidewall thereof. The bottom of the groove has a protrusion member in form of a plurality of bumps or a convex stripe. The annular base is connected with the curved pipe. The fixing rings are arranged on the outer surface of the curved pipe. A fixing strap is passed through the fixing rings and used to bind up the power cable and the opening of the curved pipe. The present invention prevents liquid, dust and insects from entering the interior of an electric device through a power gland, exempts the electric device from short circuit and prolongs the service life of the electric device.

Below, the present invention is described in detail in cooperation with the attached drawings to make easily understood the objectives, technical contents, characteristics and accomplishments of the present invention.

### BRIEF DESCRIPTION OF THE DRAWINGS

FIG. 1 is a perspective view schematically showing a watertight and dustproof power cable gland according to one embodiment of the present invention;

FIG. 2 is a sectional view schematically showing a watertight and dustproof power cable gland according to one embodiment of the present invention;

FIG. 3 is a sectional view schematically showing the application of a watertight and dustproof power cable gland according to one embodiment of the present invention;

FIG. 4 is a perspective view schematically showing the application of a watertight and dustproof power cable gland according to one embodiment of the present invention; and

FIG. 5 is a sectional view schematically showing the structure of a groove according to one embodiment of the present invention.

### DETAILED DESCRIPTION OF THE INVENTION

In order to exempt the internal elements and circuits of an electric device from being damaged or short-circuited by external substances or organisms, the present invention discloses a watertight and dustproof power cable gland, which is an elastic power cable gland installed in a cable hole of an electric device, and which can prevent liquid, dust and insects from entering the electric device, whereby safety of the electric device is promoted.

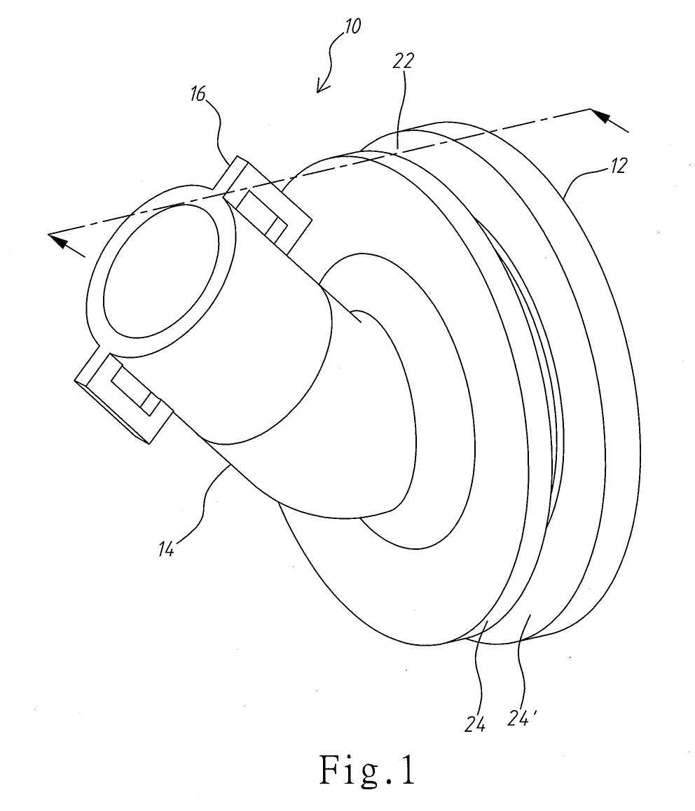

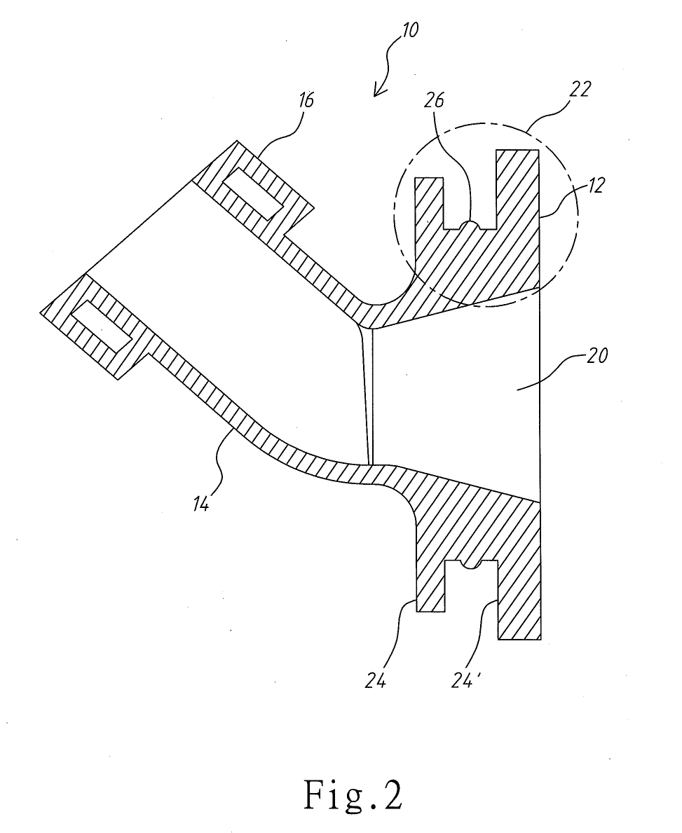

Refer to FIG. 1 a perspective view schematically showing a watertight and dustproof power cable gland according to one embodiment of the present invention. The watertight and dustproof power cable gland 10 of the present invention comprises an annular base 12, a curved pipe 14 and at least one fixing ring 16. In one embodiment, the curved pipe 14 is a flexible plastic curved pipe and others are made of a flexible plastic material. Refer to FIG. 2 a sectional view schematically showing a watertight and dustproof power cable gland according to one embodiment of the present invention. The annular base 12 has a hole 20 at the center thereof. The annular base 12 extends inward to connect with the curved pipe 14. The curved pipe 14 interconnects with the hole 20. The inner diameter of the hole gradually decreases from the annular base 12 to the curved pipe 14, whereby the inner wall of the annular base 12 and the inner wall of the curved pipe 14 jointly form an inclined surface. The sidewall of the annular base 12 has a groove 22. In one embodiment, the groove 22 encircles the sidewall of the annular base 12. The groove 22 has two walls 24 and 24′ respectively having different heights. The first wall 24 nearer to the curved pipe 14 is lower than the second wall 24′. The bottom of the groove 22 has a protrusion member 26. In one embodiment, the protrusion member 26 is in form of a plurality of bumps. In one embodiment, the protrusion member 26 is a convex stripe. In the embodiment shown in FIG. 2, a plurality of bumps is used to exemplify the protrusion member 26. The fixing rings 16 are arranged on the external wall of the curved pipe 14 and used to accommodate a fixing strap. In the embodiment shown in the drawings, the curved pipe 14 has two fixing rings 16.

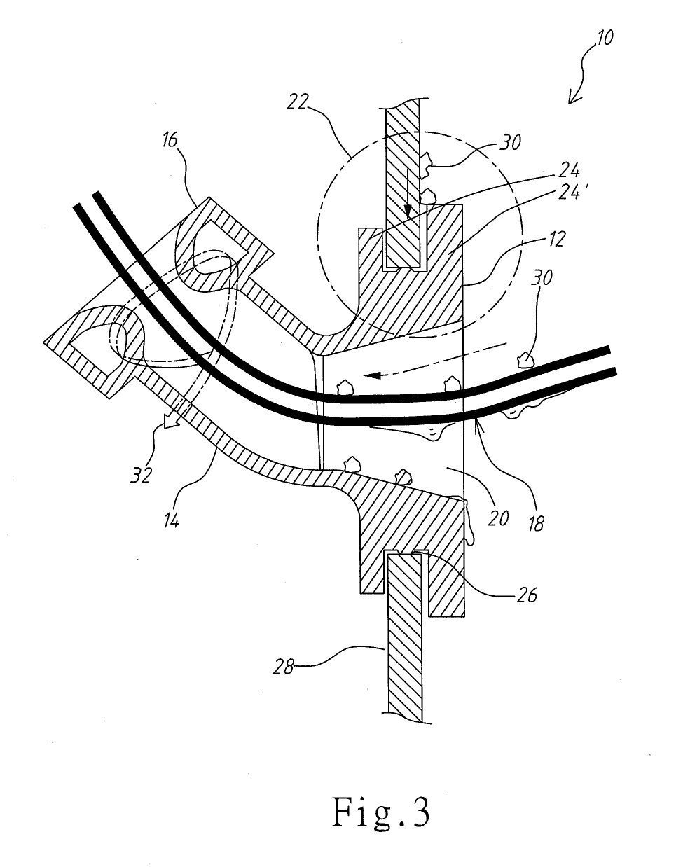

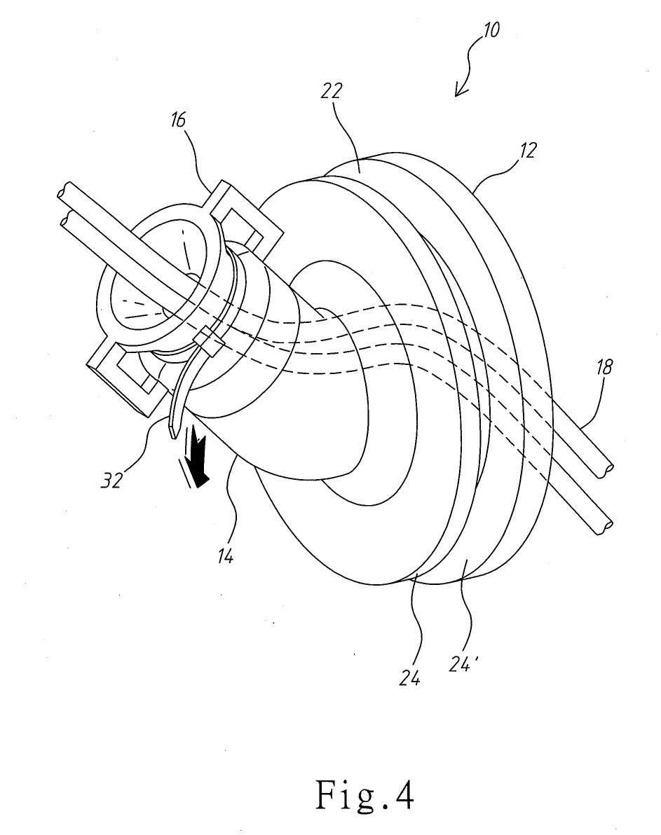

The structure of the present invention has described above. The application of the present invention is to be described below. Refer to FIG. 3 and FIG. 4. FIG. 3 is a sectional view schematically showing the application of a watertight and dustproof power cable gland according to one embodiment of the present invention. FIG. 4 is a perspective view schematically showing the application of a watertight and dustproof power cable gland according to one embodiment of the present invention. In assembling the watertight and dustproof power cable gland 10 of the present invention, the groove 22 on the sidewall of the annular base 12 is installed in the separation board 28 around the cable hole firstly. The protrusion member 26 of the groove 22 tightly contacts the separation board 28 to prevent external substances 30 and organisms, such as liquid, dust and insects, from entering the electric device via the gap between the groove 22 and the separation board 28. Next, a cable 18 is inserted through the hole 20 of the annular base 12 and the curved pipe 14. Next, a fixing strap passes through the fixing rings 16 and encircles the external wall of the curved pipe 14. In the embodiment shown in FIG. 4, a tie strap 32 is used to exemplify the fixing strap. The tie strap 32 is strained to bind up the opening of the curved pipe 14 and fix the power cable 18. Such a design can effectively prevent external substances 30 and organisms from entering the electric device. The inclined surface, which is formed by the inner walls of the annular base 12 and the curved pipe 14, gradually rises from the external to the internal. If there is liquid splashed into the hole 20 of the watertight and dustproof power cable gland 10, the liquid will not flow into the interior of the electric device but will be drained out along the inclined surface.

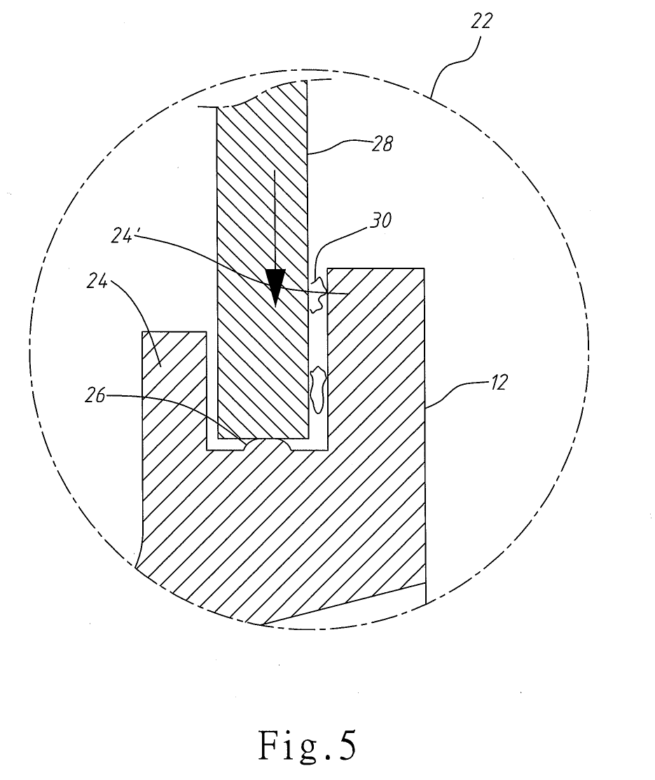

Refer to FIG. 5 a sectional view schematically showing the structure of a groove according to one embodiment of the present invention. Two walls 24 and 24′ of the groove 22 respectively have different heights. The first wall 24 nearer to the curved pipe 14 is lower than the second wall 24′. The bottom of the groove 22 has a protrusion member 26. While the power cable 18 is pulled inwards, the second wall 24′ of the groove 22 can resist the inward force, press-fitting the groove 22 to the separation board 28 and preventing the watertight and dustproof power cable gland 10 from dropping inward.

It is not necessary for an electric device to only have a single power cable 18. In fact, a current electric device may have a plurality of power cables. It is hard for a plurality of power cables to simultaneously pass the watertight and dustproof power cable gland 10. If several power cables should pass the watertight and dustproof power cable gland 10, gaps are likely to exist among the power cables. In such a case, the tie strap 32 is less likely to completely bind up the opening of the curved pipe 14.

Therefore, the present invention neither limits the annular base 12 to only have a single hole 20 nor limits the annular base 12 to only have a given size. In one embodiment, the annular base 12 has a plurality of holes all interconnecting with an identical curved pipe 14 or respectively interconnecting with different curved pipes 14, whereby is formed a watertight and dustproof power cable gland 10 able to accommodate a plurality of power cables. Except the function of accommodating a plurality of power cables, the structure and functions of this embodiment are the same as that of the abovementioned embodiments and will not repeat herein.

The embodiments described above are to demonstrate the technical thought and characteristics of the present invention to enable the persons skilled in the art to understand, make, and use the present invention. However, it should be understood that these embodiments are not intended to limit the scope of the present invention. Any equivalent modification or variation according to the spirit of the present invention is to be also included within the scope of the present invention.

What is claimed is:

1. A watertight and dustproof power cable gland comprising an annular base having at least one hole at a center thereof and having a groove along a sidewall thereof, wherein said groove has a protrusion member on a bottom thereof;
a curved pipe arranged on said annular base and interconnecting with said hole, wherein an inner wall of said curved pipe and an inner wall of said hole jointly form an inclined surface; and
at least one fixing ring arranged on an external surface of said curved pipe and accommodating a fixing strap used to bind up an opening of said curved pipe.

2. The watertight and dustproof power cable gland according to claim 1, wherein said groove is installed on a separation board, and wherein said protrusion member tightly contacts said separation board.

3. The watertight and dustproof power cable gland according to claim 2, wherein said separation board is a part of a housing of an electric device.

4. The watertight and dustproof power cable gland according to claim 1, wherein said groove has a first wall near said curved pipe and a second wall near said annular base, and wherein said first wall is lower than said second wall.

5. The watertight and dustproof power cable gland according to claim 1 further comprising a power cable passes said annular base and said curved pipe, wherein said power cable is bound up with said opening of said curved pipe by said fixing strap.

6. The watertight and dustproof power cable gland according to claim 1, wherein said annular base has a diameter gradually decreasing from a bottom of said annular base toward said curved pipe to form said inclined surface.

7. The watertight and dustproof power cable gland according to claim 1, wherein said fixing strap is a tie strap.

8. The watertight and dustproof power cable gland according to claim 1, wherein said protrusion member is in form of a plurality of bumps.

9. The watertight and dustproof power cable gland according to claim 1, wherein said protrusion member is a convex stripe.

10. The watertight and dustproof power cable gland according to claim 1, wherein said curved pipe is a flexible plastic curved pipe.
